(19) United States
(12) Patent Application Publication
(10) Pub. No.: US 2008/0237312 A1
(43) Pub. Date: Oct. 2, 2008

(54) Brazing method

(75) Inventors: Haruhiko Watanabe, Yokkaichi-city (JP); Sumio Susa, Anjo-city (JP); Masaki Harada, Anjo-city (JP); Toshifumi Kamo, Tokai-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/079,246

(22) Filed: Mar. 25, 2008

(30) Foreign Application Priority Data
Mar. 27, 2007 (JP) 2007-082704

(51) Int. Cl. B23K 31/02

(52) U.S. Cl. 228/183

(57) ABSTRACT

In a brazing method, tubes for a heat exchanger, in which an inner fluid flows and exchanges heat with an outer fluid, are bonded to fins for expanding a heat exchange area at a time of exchanging the heat, by using a brazing material of paste form. The method includes a mounting step of stacking the tubes and the fins alternately in layers to form an assembly, a coating step of coating portions near outside abutting portions where the tubes abut on the fins with the brazing material after the mounting step, and a brazing step of carrying the assembly coated with the brazing material in the coating step into a brazing furnace and of brazing the tubes to the fins.

### CROSS REFERENCE TO RELATED APPLICATION

This application is based on Japanese Patent Application No. 2007-82704 filed on Mar. 27, 2007, the contents of which are incorporated herein by reference in its entirety.

### FIELD OF THE INVENTION

The present invention relates to a method for brazing tubes to fins for a heat exchanger.

### BACKGROUND OF THE INVENTION

A method for brazing a heat exchanger in the related art is disclosed in, for example, JP-A-2005-118826. In the method, the tube abutting surfaces in which fins abut on tubes are previously coated with a copper-based brazing material of paste form, which contains phosphorus, in such a way that the base material of the tubes is exposed, and the fins are mounted on the tubes, and then the fins are brazed to the tubes in the furnace of a reducing atmosphere. As for the coating of the brazing material, for example, the tube abutting surfaces are coated with plural lines of brazing material in such a way that the plural lines of brazing material extend in lines in a longitudinal direction of the tubes.

With this, portions in which the base material of the tube abutting surfaces is exposed have an oxidized film surely removed by the phosphorus in the brazing material and by the reducing atmosphere and the melted brazing material flows into the clearances between the tubes (tube abutting surfaces) and the fins, thereby producing an excellent brazing state.

Whether the quality of brazing of parts (tubes and fins) is good or bad is determined by how well the brazing material can penetrate the clearances between the parts by a capillary effect. It is known that generally this capillary effect is inversely proportional to the density ρ of the brazing material and the clearance d between the parts, as shown by a mathematical equation 1 and in FIG. 8.

h=2γ/dρg (Mathematical equation 1)

in which

h=capillary rising height

γ=surface tension of brazing material

d=clearance between parts

ρ=density of brazing material

g=gravitational acceleration

Thus, in order to enhance the quality of brazing, the clearance needs to be set as small as possible. In addition, when material having higher density (for example, copper-base material as compared with aluminum-based material) is selected as the material of a heat exchanger, the clearance needs to be set more smaller by an increase in the density of the brazing material.

However, in the related art described above, when the fins are mounted on the tubes, clearances are produced between the fins and the tubes by the brazing material with which the tube abutting surfaces are partially coated in such a way that the base material of the tubes is exposed, and hence a sufficient capillary effect is hard to produce.

### SUMMARY OF THE INVENTION

In view of the above-mentioned problems, an object of the present invention is to provide a brazing method capable of producing an excellent brazing state in the case of using a brazing material of paste form.

According to one example of the present invention, in a brazing method, tubes for a heat exchanger, in which an inner fluid flows and exchanges heat with an outer fluid, are bonded to fins for expanding a heat exchange area at a time of exchanging the heat, by using a brazing material of paste form. The method includes a mounting step of stacking the tubes and the fins alternately in layers to form an assembly, a coating step of coating portions near outside of abutting portions where the tubes abut on the fins with the brazing material after the mounting step, and a brazing step of carrying the assembly coated with the brazing material in the coating step into a brazing furnace and of brazing the tubes to the fins.

With this, in the mounting step, the assembly can be formed without producing clearances between the tubes and fins by the brazing material. In the brazing step, the brazing material applied to portions near outside of the abutting portions where the tubes abut on the fins melts and surely penetrates the clearances between the parts abutting on each other by its capillary effect so as to produce an excellent brazing state.

For example, in the coating step, as the portions near outside of the abutting portions, end surfaces of end portions in a direction of flow of the outer fluid of the tubes are coated with the brazing material. In this case, in the coating step, it is possible to easily coat the assembly with the brazing material.

In the coating step, adjacent end surfaces adjacent to the fins of the end surfaces are coated with the brazing material. In this case, it is possible to make the melting brazing material penetrate the clearances between the tubes and the fins with reliability and without loss.

Alternatively, in the coating step, the end surfaces are coated with the brazing material continuously in a longitudinal direction of the tubes. With this, it is possible to easily coat the tubes with the brazing material, and hence to realize automation using a dispenser or the like.

For example, the tubes, the fins, and the brazing material are made of copper or copper-based alloy.

The brazing material made of copper or copper-based alloy has a larger density (specific gravity) than, for example, a brazing material made of aluminum-based alloy. Hence, in order to produce the capillary effect, it is necessary to further reduce the clearances between the tubes and the fins. Thus, this brazing method of forming the assembly without producing the clearances between the tubes and fins in the mounting step and capable of brazing the parts with reliability can be employed as suitable means.

Moreover, the inner fin may be inserted into the tube. In the tube having the inner fin inserted thereinto, the spring force in the stacking direction of the tube becomes very larger than the spring force of the fin. Further, if the tubes or the fins are coated with the brazing material, when the fins are mounted on the tubes to form the assembly, the size of the assembly in the stacking direction in which the tubes and the fins are stacked is increased by the thickness of the brazing material. Then, when this assembly is mounted on the header tanks, the assembly needs to be compressed in the stacking direction, but at this time there is a possibility that the fins may be buckled because they are smaller in the spring force.

In this brazing method, the brazing material is applied after the mounting step, so that the size of the assembly in the stacking direction is not increased by the brazing material. Thus, it is possible to prevent the fins from being buckled.

### BRIEF DESCRIPTION OF THE DRAWINGS

FIG. 1 is a front view showing an intercooler according to a first embodiment of the present invention.

FIG. 2 is a sectional view taken along the line II-II in FIG. 1.

FIG. 3 is a sectional view showing a state where a brazing material is applied.

FIG. 4 is an enlarged view showing the IV portion in FIG. 3.

FIG. 5 is a sectional view showing the procedure of applying brazing material.

FIG. 6 is a graph showing displacement to load in a tube and an outer fin.

FIG. 7 is a sectional view showing an outer fin in a second embodiment.

FIG. 8 is a model diagram for illustrating a capillary effect.

### DETAILED DESCRIPTION OF THE PREFERRED EMBODIMENTS

### First Embodiment

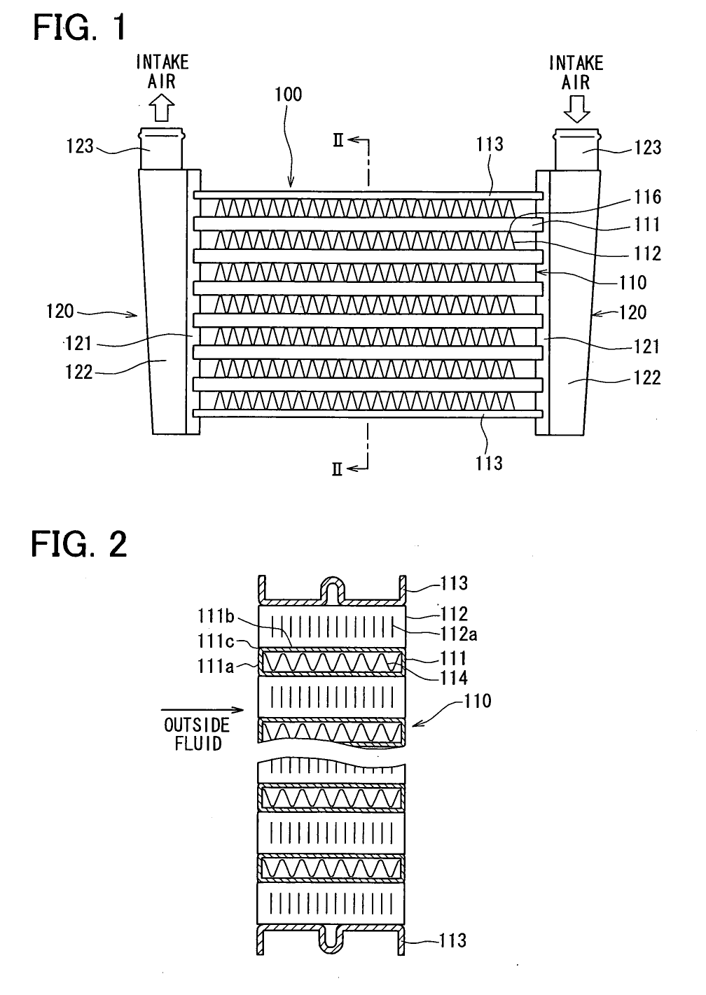

This embodiment is an example in which a brazing method according to the present invention is applied to a core part 110 of an air-cooled intercooler 100 and will be described below with reference to FIG. 1 to FIG. 5.

The intercooler 100 is a heat exchanger for exchanging heat between air for combustion (hereinafter referred to as “intake air”) sucked into an engine (internal combustion engine) for a vehicle and cooling air from the outside to cool the intake air. This intercooler 100 includes the core parts 110 and a pair of header tanks 120 as main parts. The intercooler 100 is assumed to be a large-size intercooler mounted on a large-size vehicle such as a truck. Thus, respective parts to be described below are made of copper, copper-based alloy, or iron so as to have sufficient thermal conductivity and durability and the abutting portions of the respective parts are bonded by brazing or welding.

A brazing material used at the time of brazing is a copper-based brazing material composed of components, for example, 75% copper, 15% tin, 5% nickel, and 5% phosphorus and having a low melting point and a reducing property. Moreover, the brazing material is mixed with a binder into a brazing material of paste form and is applied for use to the abutting portions of the respective parts or to portions near the abutting portions.

The core part 110 is formed of tubes 111 each having an inner fin 114 inserted thereinto, outer fins 112, and side plates 113, the tubes 111 and the outer fins 112 being stacked in layers, the side plates 113 being arranged on the outermost portions in the direction in which the tubes 111 and the outer fins 112 are stacked in layers.

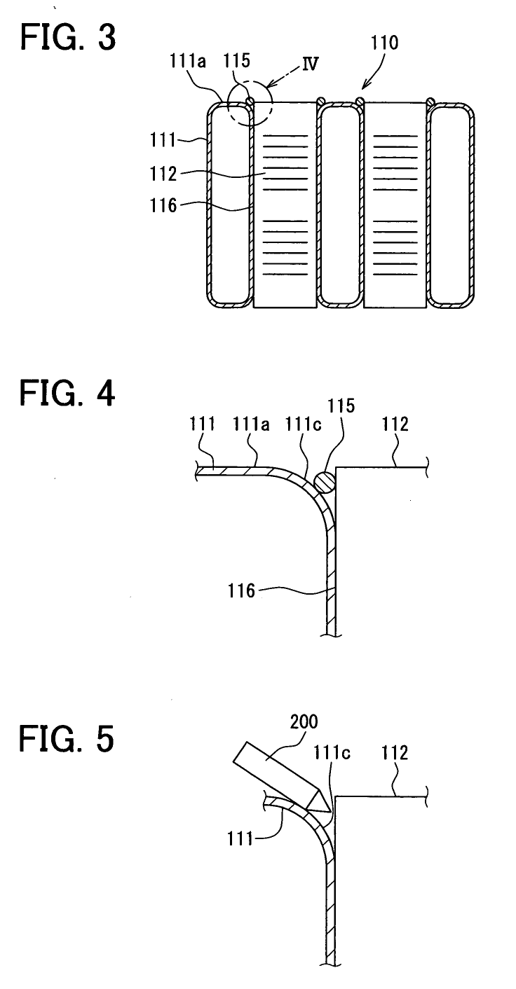

The tube 111 is a pipe in which intake air (inner fluid) flows and is formed of red brass. Although omitted in detailed sectional view in FIG. 2 and FIG. 3, the tube 111 is formed by combining two plate parts for a tube with each other, each of which is shaped like a letter C in cross section, and has a cross section formed nearly in a flat square so as to increase a cross sectional area as much as possible within a limited space and to decrease the flowing resistance of the intake air.

As shown in FIG. 2, of the surfaces of the tube 111, a surface which becomes an end portion in the direction of flow of the cooling air (outer fluid) becomes an end surface 111a and a surface on which the outer fin 112 abuts becomes an abutting surface 111b. Moreover, as shown in FIG. 3 and FIG. 4, each of the corners of the flat square cross section is formed into a round shape by bending the plate part for a tube, and of the end surface 111a formed into the round shape, a surface adjacent to the outer fin 112 becomes an adjacent end surface 111c.

The inner fin 114 inserted into the tube 111 is formed by forming a flat thin plate made of pure copper into a wavy shape and provides a turbulence effect to the flow of the intake air to enhance the heat transfer rate of the intake air. Here, the cross section of the tube 111 is formed in the flat square, so that the inner fin 114 is effectively housed in the tube 111 without producing a dead space.

The outer fin (corresponding to a fin of the present invention) 112, just as with the inner fin 114, is formed by forming a flat thin plate made of pure copper into a wavy shape. The flat surface of the outer fin 112 is plurally cut and raised into a jalousie, that is, has plural louvers 112a. Hence, the outer fin 112 expands a heat radiation area (heat exchange area) to the cooling air and produces a turbulence effect by the louvers 112 to accelerate heat exchange between the outer fin 112 and the cooling air. The size in the direction of flow of the cooling air of the outer fin 112 is set nearly equal to the size in the direction of cooling air of the tube 111.

The side plate 113 is a reinforcing part made of brass and extended in the longitudinal direction of the tube 111 and is formed nearly in a letter C in cross section and has a rib formed at the inside center of the letter C, the rib extending in the longitudinal direction.

The abutting portions 111b of the tube 111 (plate part for a tube) and the wavy crest portions of the outer fin 112 form abutting portions 116 where they abut against each other and are brazed to each other by a brazing material 115. Moreover, the outermost outer fin 112 is similarly brazed to the side plate 113 by the brazing material 115.

Moreover, the inner fin 114 is brazed to the inside surface of the tube 111 by the brazing material previously applied to the inside surface of the tube 111 (plate part for a tube). Here, the brazing material may be replaced by a foil brazing material in place of the brazing material of paste form and the foil brazing material may be interposed between the tube 111 and the inner fin 114.

The pair of header tanks 120 are disposed on both ends in the longitudinal direction of the tube 111 (hereinafter referred to as “tube end portions”) and are extended in the direction in which the tubes 111 are stacked in layers and are connected to the respective tubes 111. Each of these header tanks 120 includes a header plate 121, a tank body 122, and a pipe 123.

The header plate 121 is a part having an erect edge portion on an outer peripheral portion of a slender flat plate late and has tube holes formed at the positions where the tube end portions correspond to the erect edge portion. Each of the tube holes is formed in a size a little larger than the cross-sectional shape of the tube 111 in consideration of enhancing ease with which the tube 111 can be inserted the tube hole and a chamfered portion is formed on the peripheral edge of the tube hole on the side where the tube 111 is inserted (omitted in the drawing).

Here, the material of the header plate 121 is an iron material (for example, stainless steel or steel) and the obverse and reverse surfaces near the tube holes except for the erect edge portions are plated or clad with pure copper.

The tube end portions are inserted into and fitted to the tube holes and the tubes 111 and the header plate 121 are brazed by the brazing material at portions where they abut on each other. Here, both ends in the longitudinal direction of the side plate 113 abut on the header plates 121 and are brazed to the header plates 121 by the brazing material.

The tank body 122 is formed of the same iron material as the header plate 121. The tank body 122 is a slender semi-container opening on the header plate 121 side and the opening side is welded to the erect edge portion of the header plate 121 to form a tank inner space.

The pipe 123 is a pipe part made of an iron material and is welded to one end in the longitudinal direction of the tank body 122 so as to connect to the tank inner space.

In this respect, the right header tank 120 in FIG. 1 distributes for supply the intake air flowing into from the pipe 123 to the respective tubes 111, whereas the left header tank 120 in FIG. 1 collects and recovers the intake air flowing out of the tubes 111 and flows out the intake air from the pipe 123 to the outside.

Next, a schematic manufacturing method of the intercooler 100 will be described.

### 1. Part Preparing Step

First, the plate parts for a tube (tube 111) formed by pressing a plate part, the side plates 113, the header plates 121, the outer fins 112 formed by rolling, the inner fins 114 are prepared. The brazing material of paste form is previously applied to the inner surfaces of the plate parts for a tube and is dried. Moreover, the brazing material of paste form is previously applied to the peripheral portions of the tube holes of the header plates 121 and the portions where both ends in the longitudinal direction of the side plates 113 abut on the header plates 121 and is dried.

### 2. Core Part Mounting Step

The side plate 113 is set on the lowest side by using a stacking jig (not shown) as a guide. Then, the outer fins 112, the plate parts for a tube, the inner fins 114, the plate parts for a tube, and the outer fins 112 are repeatedly stacked on the side plate 113 by respective specified numbers in this order. Then, another side plate 113 is further set on the upper side of the uppermost outer fin 112. In this manner, the assembly of the core part 110 is formed. At this time, the assembly of the tube 111 into which the inner fin 114 is inserted is formed by stacking the plate parts for a tube and the inner fins 114 in layers.

Next, the tube end portions are inserted into and fitted to the tube holes of the header plates 121 and both end portions in the longitudinal direction of the side plates 113 are abutted on the header plates 121. Here, if necessary, so as to hold the state of assembly of the core part 110, jigs such as wires are mounted in the direction in which the tubes 111 are stacked in layers.

### 3. Brazing Material Applying Step

As shown in FIG. 3 to FIG. 5, the assembly of the core part 110 is arranged in such a way that the direction in which the tubes 111 are stacked in layers becomes horizontal and portions near outside the abutting portions 116 where the tubes 111 abut on the outer fins 112 are coated with the brazing material 115 of paste form. Here, the portions near outside the abutting portions 116 are the end surfaces 111a of the tubes 111. Moreover, of these end surfaces 111a, the adjacent end surfaces 111c adjacent to the outer fins 112 are coated with the brazing material 115. When the adjacent end surfaces 111c are coated with brazing material 115, the brazing material 115 is supplied continuously along the longitudinal direction of the tube 111 by using the adjacent end surface 111c as a guide by the use of a dispenser 200, whereby the adjacent end surfaces 111c are coated with brazing material 115. Here, portions corresponding to the adjacent end surfaces 111c of the side plates 113 are also coated with the brazing material 115.

### 4. Brazing Step

The assembly is degreased and then the assembly of the core part 110 is carried into a brazing furnace in such a way that the direction in which the tubes 111 are stacked in layers becomes horizontal and the respective parts are integrally brazed (here, a brazing temperature is 625° C.). In other words, the brazing material 115 applied to the adjacent end surfaces 111c of the tubes 111 and the side plates 113 and the brazing material previously applied to the inside surfaces of the plate parts for a tube and the header plates 121 melt in the brazing furnace and penetrate the abutting portions of the respective parts by a capillary effect, whereby brazing the abutting portions of the respective parts is performed. Specifically, brazing the tubes 111 to the outer fins 112 at the abutting portions 116, brazing the outer fins 112 to the side plates 113, brazing the tubes 111 to the header plates 121 (tube holes), brazing the side plates 113 to the header plates 121, and brazing the tubes 111 to the inner fins 114 are performed.

Then, the pipes 123 are welded to the tank bodies 122 formed by pressing. Moreover, the opening sides of the tank bodies 122 are fitted to the erect edge portions of the header plates 121 of the core part 110 taken out of the brazing furnace, and then the tank bodies 122 are welded to the header plates 121.

### 5. Inspection Step

Thereafter, specified inspections such as a leak inspection (inspection for faulty brazing and faulty welding) and a size inspection are performed. In this manner, the manufacture of the intercooler 100 is completed.

In this embodiment, in the brazing material applying step set after the core part mounting step, the brazing material 115 is applied to the adjacent end surfaces 111c of the tubes 111, so that the assembly can be formed in the core part mounting step without clearances being produced particularly between the tubes 111 and the outer fins 112 by the brazing material 115. In the brazing step, the brazing material 115 applied to the adjacent end surfaces 111c melts and surely penetrates portions (abutting portions 116) between the tubes 111 and the outer fins 112 by its capillary effect, thereby producing an excellent brazing state.

Moreover, in the brazing material applying step, the brazing material 115 is applied to the adjacent end surfaces 111c of the end surfaces 111a of the tubes 111, so that the brazing material 115 can be easily applied to the assembly. Furthermore, it is possible to make the melting brazing material 115 penetrate the portions between the tubes 111 and the outer fins 112 with reliability and without loss.

Further, in the brazing material applying step, the brazing material 115 is applied to the tubes 111 continuously in the longitudinal direction of the tube 111, so that the brazing material 115 can be easily applied to the tubes 111, which can realize automation using the dispenser 200 and the like.

Still further, immediately after the brazing material 115 is applied to the adjacent end surfaces 111c, the brazing step can be started. Thus, this can eliminate the need for providing a step for drying the applied brazing material 115 and hence can enhance productivity.

Still further, the brazing material 115 made of copper or copper-based alloy is used in this embodiment, but the brazing material 115 of this kind has a larger density (specific gravity) than, for example, a brazing material made of aluminum-based alloy. Thus, so as to produce the capillary effect, the brazing material 115 needs to make the clearances between the parts to be brazed (between the tubes 111 and the outer fins 112) smaller than the brazing material made of aluminum-based alloy. Thus, this brazing method of forming the assembly without producing the clearances between both parts 111, 112 in the core part mounting step and capable of brazing the parts with reliability can be employed as suitable means.

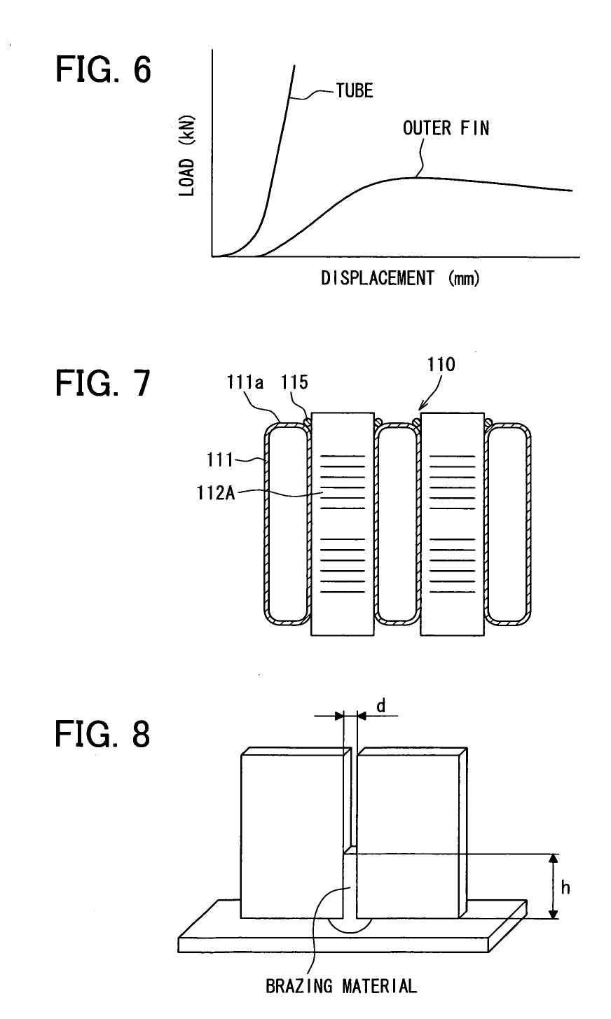

Still further, the inner fin 114 is inserted into the tube 111 in this embodiment, but in the tube 111 having the inner fin 114 inserted thereinto, as shown in FIG. 6, a spring force in the direction in which the tubes 111 are stacked in layers becomes very larger than a spring force of the outer fin 112 (displacement to load becomes very small). Moreover, if the tubes 111 or the fins 112 are previously coated with the brazing material 115, when the fins 111 are mounted on the tubes 112 to form the assembly, the size of the assembly in the stacking direction in which the tubes 111 and the fins 112 are stacked is increased by the thickness of the brazing material. Then, when this assembly is mounted on the header tanks 120, the assembly needs to be compressed in the stacking direction, but at this time there is a possibility that the outer fins 112 may be buckled because they are smaller in the spring force.

In this embodiment, the brazing material 115 is applied after the core part mounting step, so that the size in the stacking direction of the assembly is not increased by the brazing material 115, which can prevent the outer fins 112 from being buckled as described above. Thus, this brazing method can be employed as a suitable method at the time of brazing the tubes 111 each having the inner fin 114 inserted thereinto to the outer fins 112.

According to the brazing method of the first embodiment of the present invention, the tubes 111 for the heat exchanger 100, in which an inner fluid flows and exchanges heat with an outer fluid, are bonded to the fins 112 for expanding a heat exchange area at a time of exchanging the heat, by using the brazing material 115 of paste form. The method includes the mounting step of stacking the tubes 111 and the fins 112 alternately in layers to form an assembly, the coating step of coating portions 111a, 111c near outside of abutting portions 116 where the tubes 111 abut on the fins 112 with the brazing material 115 after the mounting step, and the brazing step of carrying the assembly coated with the brazing material 115 in the coating step into a brazing furnace and of brazing the tubes 111 to the fins 112.

With this, in the mounting step, the assembly can be formed without producing clearances between the tubes 111 and fins 112 by the brazing material. In the brazing step, the brazing material applied to portions near outside of the abutting portions where the tubes 111 abut on the fins 112 melts and surely penetrates the clearances between the parts abutting on each other by its capillary effect so as to produce an excellent brazing state.

### Second Embodiment

A second embodiment of the present invention is shown in FIG. 7. The size in the direction of flow of the cooling air of an outer fin 112A may be made larger than the size in the direction of flow of the cooling air of the tube 111. In other words, the end portions of the outer fins 112A may be protruded from the end surfaces 111b of the tubes 111. Also in this case, just as with the first embodiment, the brazing material 115 can be easily applied and hence an excellent brazing state can be produced.

### Other Embodiments

Although the present invention has been fully described in connection with the preferred embodiments thereof with reference to the accompanying drawings, it is to be noted that various changes and modifications will become apparent to those skilled in the art.

In the above-mentioned respective embodiments, the brazing material 115 is applied to the adjacent end surfaces 111c of the tubes 111, but if the fluidity of the brazing material 115 is excellent, the brazing material 115 may be applied to the end surfaces 111a.

Moreover, it is also recommendable to apply the brazing material 115 to a portion nearly in the center of the end surface 111a in one tube 111 and to make the brazing material 115 flow to the outer fins 112 on both sides of the portion. With this, the number of man-hours required to apply the brazing material 115 can be reduced.

Further, the brazing material 115 is applied to the end surfaces 111a (adjacent end surfaces 111c) of the tubes 111 continuously in the longitudinal direction of the tube 111. However, the brazing material 115 may be applied to the end surfaces 111a intermittently at the abutting portions 116 of the tubes 111 and the outer fins 112 (crest portions of the outerfins 112) in the longitudinal direction of the tube 111. With this, the amount of use of the brazing material 115 can be reduced to a minimum amount.

Still further, when the tubes 111 are brazed to the outer fins 112, the brazing material 115 is applied after the core part mounting step. However, when the tubes 111 are brazed to the header plates 121 (tube holes), the brazing material may be applied to the end surfaces 111a of the tubes 111 or to the portions around the tube holes after fitting the tubes 111 in the tube holes. With this, the reliability with which the tubes 111 are fitted in the tube holes can be ensured and the clearances between them can be suitably ensured and hence an excellent brazing state can be produced.

Still further, the basic material of the parts constructing the heat exchanger are copper or copper-based alloy in the first and second embodiments, but the present invention can be applied also to a heat exchanger formed of other material such as aluminum and aluminum-based alloy.

Still further, depending on the material of the constituent parts to be selected, the brazing material may be solder and parts to be soldered may be the object of the present invention.

Still further, the heat exchanger is not limited to the intercooler, but may be other heat exchanger such as a radiator and a condenser.

Such changes and modifications are to be understood as being within the scope of the present invention as defined by the appended claims.

What is claimed is:

1. A brazing method for bonding tubes for a heat exchanger, in which an inner fluid flows and exchanges heat with an outer fluid, to fins for expanding a heat exchange area at a time of exchanging the heat, by using a brazing material of paste form, the method comprising:
a mounting step of stacking the tubes and the fins alternately in layers to form an assembly;
a coating step of coating portions near outside of abutting portions where the tubes abut on the fins with the brazing material after the mounting step; and
a brazing step of carrying the assembly coated with the brazing material in the coating step into a brazing furnace and of brazing the tubes to the fins.

2. The brazing method as in claim 1, wherein
in the coating step, as the portions near outside of the abutting portions, end surfaces of end portions in a direction of flow of the outer fluid of the tubes are coated with the brazing material.

3. The brazing method as in claim 2, wherein
in the coating step, adjacent end surfaces adjacent to the fins of the end surfaces are coated with the brazing material.

4. The brazing method as in claim 2, wherein
in the coating step, the end surfaces are coated with the brazing material continuously in a longitudinal direction of the tubes.

5. The brazing method as in claim 1, wherein
the tubes, the fins, and the brazing material are made of copper or copper-based alloy.

6. The brazing method as in claim 1, wherein each of the tubes has an inner fin inserted thereinto.
